(19) United States
(12) Patent Application Publication
(10) Pub. No.: US 2025/0018570 A1
(43) Pub. Date: Jan. 16, 2025

(54) HYBRID MOTION PLANNING FOR ROBOTIC DEVICES

(71) Applicant: Blue Origin, LLC, Kent, WA (US)

(72) Inventor: Sherif Ahmed Shazly, Seattle, WA (US)

(21) Appl. No.: 18/222,355

(22) Filed: Jul. 14, 2023

(51) Int. Cl. B25J 9/16

(52) U.S. Cl. CPC B25J 9/1666; B25J 9/161; B25J 9/163

(57) ABSTRACT

An improved robotic device motion planning system that is capable of producing motion plans for accomplishing a task that are deterministic and at a higher success rate than typical systems is described herein. For example, the improved robotic device motion planning system may implement a hybrid motion planning approach in which the robotic device motion planning system initially attempts to develop a motion plan for a robotic device using a real-time motion planning algorithm. If the robotic device motion planning system is unable to develop a motion plan using a real-time motion planning algorithm, then the robotic device motion planning system may attempt to develop the motion plan using a sampling method.

### TECHNICAL FIELD

The present disclosure generally relates to motion planning for robotic devices, such as robotic devices that operate in space.

### BACKGROUND

A robotic device can be configured to move toward a target using a motion plan or path plan. For example, a motion plan may identify a sequence of movements that joints or other parts of the robotic device can implement to move the robotic device from an initial position to the target. The motion plan may take into account the position of obstacles such that no part of the robotic device collides with an obstacle in the process of moving from the initial position to the target. A motion plan may be capable of controlling movement of a robotic device in a number of different environments, including robotic devices that are present in orbit around the Earth, in orbit around an extraterrestrial object (e.g., the Moon, a planet, an asteroid, etc.), and/or in other areas of space.

### SUMMARY

The systems, methods, and devices described herein each have several aspects, no single one of which is solely responsible for its desirable attributes. Without limiting the scope of this disclosure, several non-limiting features will now be discussed briefly.

One aspect of the disclosure provides a system for generating a motion policy for a robotic device. The system comprises memory that stores computer-executable instructions. The system further comprises a processor in communication with the memory, where the computer-executable instructions, when executed by the processor, cause the processor to: process a request to move a subcomponent of the robotic device to a target position; obtain sensor data from the robotic device; determine one or more subtasks for moving the subcomponent of the robotic device to the target position using the sensor data; generate a directed tree using the determined one or more subtasks; traverse the directed tree recursively to generate a global configuration space policy; determine that the global configuration space policy, when implemented, results in the subcomponent of the robotic device reaching an equilibrium state at a second position that is at least a threshold distance from the target position; generate a randomized motion policy in response to the determination that the global configuration space policy results in the subcomponent of the robotic device reaching the equilibrium state at the second position; and cause the robotic device to move the subcomponent of the robotic device to the target position according to the randomized motion policy.

The system of the preceding paragraph can include any sub-combination of the following features: where the computer-executable instructions, when executed, further cause the processor to: decompose an overall task of moving the subcomponent to the target position into the one or more subtasks, and generate a Riemannian motion policy for each subtask in the one or more subtasks; where the computer-executable instructions, when executed, further cause the processor to generate a root node, one or more child nodes, and one or more leaf nodes to form the directed tree, where each leaf node in the one or more leaf nodes represents one of the one or more subtasks; where the computer-executable instructions, when executed, further cause the processor to: apply a pushforward operation to the directed tree in a first pass, apply a pullback operation to the directed tree in a second pass, and apply a resolve operation to results of the pushforward operation and the pullback operation to generate the global configuration space policy; where the computer-executable instructions, when executed, further cause the processor to: select a random position that is between nodes of a search tree and the target position, identify a first node in the search tree that is a closest node in the search tree to the selected random position, determine that motion from the first node to the selected random position is collision-free, add a second node to the search tree that corresponds to the selected random position and a link between the first node and the second node, add one or more additional nodes to the search tree until one of the additional nodes is within the threshold distance of the target position, and identify a shortest path between a third node in the search tree that represents an initial position of the subcomponent and the one of the additional nodes that is within the threshold distance of the target position, where the shortest path represents the randomized motion policy; where the request to move the subcomponent comprises an indication of a location of the target position and an indication of a behavior for the subcomponent to perform when reaching the target position; where the behavior comprises one of follow, move to pose, move towards pose, grasp, release, scan, catch, throw, push, pull, handoff, drill, or weld; where the computer-executable instructions, when executed, further cause the processor to cause the subcomponent of the robotic device to perform the behavior when the subcomponent of the robotic devices reaches the target position; where the subcomponent of the robotic device comprises an end effector of the robotic device; and where the directed tree comprises a Riemannian motion policy tree.

Another aspect of the disclosure provides a computer-implemented method for generating a motion policy for a robotic device. The computer-implemented method comprises: receiving a request to move a subcomponent of the robotic device to a target position; determining one or more subtasks for moving the subcomponent of the robotic device to the target position; generating a directed tree using the determined one or more subtasks; traversing the directed tree recursively to generate a global configuration space policy; determining that the global configuration space policy, when implemented, results in the subcomponent of the robotic device reaching an equilibrium state at a second position that is at least a threshold distance from the target position; generating a randomized motion policy in response to the determination that the global configuration space policy results in the subcomponent of the robotic device reaching the equilibrium state at the second position; and causing the robotic device to move the subcomponent of the robotic device to the target position according to the randomized motion policy.

The computer-implemented method of the preceding paragraph can include any sub-combination of the following features: where determining one or more subtasks further comprises: decomposing an overall task of moving the subcomponent to the target position into the one or more subtasks, and generating a Riemannian motion policy for each subtask in the one or more subtasks; where generating a directed tree further comprises generating a root node, one or more child nodes, and one or more leaf nodes to form the directed tree, where each leaf node in the one or more leaf nodes represents one of the one or more subtasks; where traversing the directed tree further comprises: applying a pushforward operation to the directed tree in a first pass, applying a pullback operation to the directed tree in a second pass, and applying a resolve operation to results of the pushforward operation and the pullback operation to generate the global configuration space policy; where generating a randomized motion policy further comprises: selecting a random position that is between nodes of a search tree and the target position, identifying a first node in the search tree that is a closest node in the search tree to the selected random position, determining that motion from the first node to the selected random position is collision-free, adding a second node to the search tree that corresponds to the selected random position and a link between the first node and the second node, adding one or more additional nodes to the search tree until one of the additional nodes is within the threshold distance of the target position, and identifying a shortest path between a third node in the search tree that represents an initial position of the subcomponent and the one of the additional nodes that is within the threshold distance of the target position, where the shortest path represents the randomized motion policy; where the request to move the subcomponent comprises an indication of a location of the target position and an indication of a behavior for the subcomponent to perform when reaching the target position; where the behavior comprises one of follow, move to pose, move towards pose, grasp, release, scan, catch, throw, push, pull, handoff, drill, or weld; and where the computer-implemented method further comprises causing the subcomponent of the robotic device to perform the behavior when the subcomponent of the robotic devices reaches the target position.

Another aspect of the disclosure provides a non-transitory, computer-readable medium comprising computer-executable instructions for generating a motion policy for a robotic device, where the computer-executable instructions, when executed by a computer system, cause the computer system to: process a request to move a subcomponent of the robotic device to a target position; generate a directed tree based on the request; traverse the directed tree recursively to generate a global configuration space policy; determine that the global configuration space policy, when implemented, results in the subcomponent of the robotic device reaching an equilibrium state at a second position that is at least a threshold distance from the target position; generate a randomized motion policy in response to the determination that the global configuration space policy results in the subcomponent of the robotic device reaching the equilibrium state at the second position; and cause the robotic device to move the subcomponent of the robotic device to the target position according to the randomized motion policy.

The non-transitory, computer-readable medium of the preceding paragraph can include any sub-combination of the following: where the request to move the subcomponent comprises an indication of a location of the target position and an indication of a behavior for the subcomponent to perform when reaching the target position, and where the computer-executable instructions, when executed, further cause the computer system to cause the subcomponent of the robotic device to perform the behavior when the subcomponent of the robotic devices reaches the target position.

### BRIEF DESCRIPTION OF DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram of an illustrative operating environment in which a motion planning system determines a motion plan for a robotic device.

FIG. 2 is a flow diagram illustrating the operations performed by the components of the operating environment of FIG. 1 to generate a motion plan using a hybrid approach.

FIGS. 3A-3B illustrate an example virtual potential field.

FIGS. 4A-4B illustrate another example virtual potential field.

FIG. 5 is a flow diagram depicting an example motion policy generation routine illustratively implemented by a motion planning system, according to one embodiment.

### DETAILED DESCRIPTION OF SPECIFIC EMBODIMENTS

As described above, a robotic device can be configured to move toward a target or otherwise accomplish a task using a motion plan or path plan. For a robotic device in orbit, on an extraterrestrial object, or otherwise in space, the motion plan can be used to cause the robotic device to perform one of several tasks. For example, the motion plan can be used to cause the robotic device to service a satellite, to perform deep space habitat maintenance and/or repair, to repair equipment (e.g., a telescope, such as Hubble, Webb, etc.), to assemble equipment in space, to perform inertial transfer, to capture a visiting vehicle, to service a space station, to perform space robotics research, to sample a surface of an extraterrestrial object, to capture an adversarial vehicle, and/or the like. To perform some or all of these tasks, the robotic device may have one or more components (e.g., an arm, appendage, etc.) configured to perform one or more behaviors. Such behaviors can include follow, move to pose (e.g., offline, static, non-reactive, etc.), move towards pose (e.g., online, exploratory, reactive), grasp, release, scan, catch, throw, push, pull, handoff, drill, weld, and/or the like.

The motion plan may be configured to cause the robotic device or a component thereof to move toward a target while avoiding one or more objects present between the initial position of the robotic device and the position of the target. Typical systems may generate a motion plan that results in a collision-free movement of the robotic device toward the target using inverse kinematics, collision detection and avoidance, graph search methods, sampling methods, real-time motion policy algorithms, and/or the like.

However, motion plans generated by typical systems using these techniques are often unsuitable for safety-critical systems. Robotic devices operating in space may be performing tasks that can directly impact human life (e.g., servicing a space station, capturing a vehicle, etc.), and therefore it may be desirable that the robotic devices operate as expected. Some of the techniques used by typical systems to generate a motion plan may be unsuitable for operating a robotic device in space because the techniques may not produce deterministic motion plans. For example, a motion plan generated using sampling methods by one typical system may be different than a motion plan generated using sampling methods by another typical system, even if each system generates the motion plan under the same conditions (e.g., each system generates the motion plan for moving the robotic device from the same initial location to the same target, each system uses the same sensor data to generate the motion plan, etc.). As a result, an operator may not know exactly how components of the robotic device may move as the robotic device moves toward the target, and therefore may not know whether allowing the robotic device to operate may cause a hazard. For example, certain movements may be undesirable even if collisions are avoided because such movements may expose equipment to the Sun, cause the robotic device to move out of view of a human in space or operating other equipment, etc.

Typical systems that use real-time motion planning algorithms may be able to generate motion plans that are deterministic. However, use of the real-time motion planning algorithms alone may also be unsuitable for safety-critical systems, such as for robotic devices operating in space. For example, real-time motion planning algorithms are less robust than those algorithms that produce non-deterministic motion plans, such that a real-time motion planning algorithm may not be able to generate a motion plan for all situations. In particular, a typical system using a real-time motion planning algorithm may fail to generate a motion plan if one or more local minimums are present at positions other than the position of the target (which is described in greater detail below). As a result, there may be numerous situations in which real-time motion planning may be unable to direct a robotic device to accomplish a task (e.g., move toward a target).

Accordingly, described herein is an improved robotic device motion planning system that is capable of producing motion plans for accomplishing a task that are deterministic and at a higher success rate than typical systems that employ any of the motion planning techniques described above. For example, the improved robotic device motion planning system may implement a hybrid motion planning approach in which the robotic device motion planning system initially attempts to develop a motion plan for a robotic device using a real-time motion planning algorithm. If the robotic device motion planning system is unable to develop a motion plan using a real-time motion planning algorithm (e.g., because the robotic device comes to an equilibrium state at a local minimum position rather than at a position of a target), then the robotic device motion planning system may attempt to develop the motion plan using a sampling method (e.g., a rapidly exploring random tree). Thus, the improved robotic device motion planning system may default to generating a deterministic motion plan. If it is not possible to generate a deterministic motion plan, then the improved robotic device motion planning system may use a sampling method as a fallback option to ensure that a motion plan can be generated. As a result, the improved robotic device motion planning system can produce motion plans that are suitable for safety-critical systems, such as robotic devices that operate in space and/or that perform any of the space-related tasks described above.

The foregoing aspects and many of the attendant advantages of this disclosure will become more readily appreciated as the same become better understood by reference to the following detailed description, when taken in conjunction with the accompanying drawings.

### Example Robotic Device Motion Planning Environment

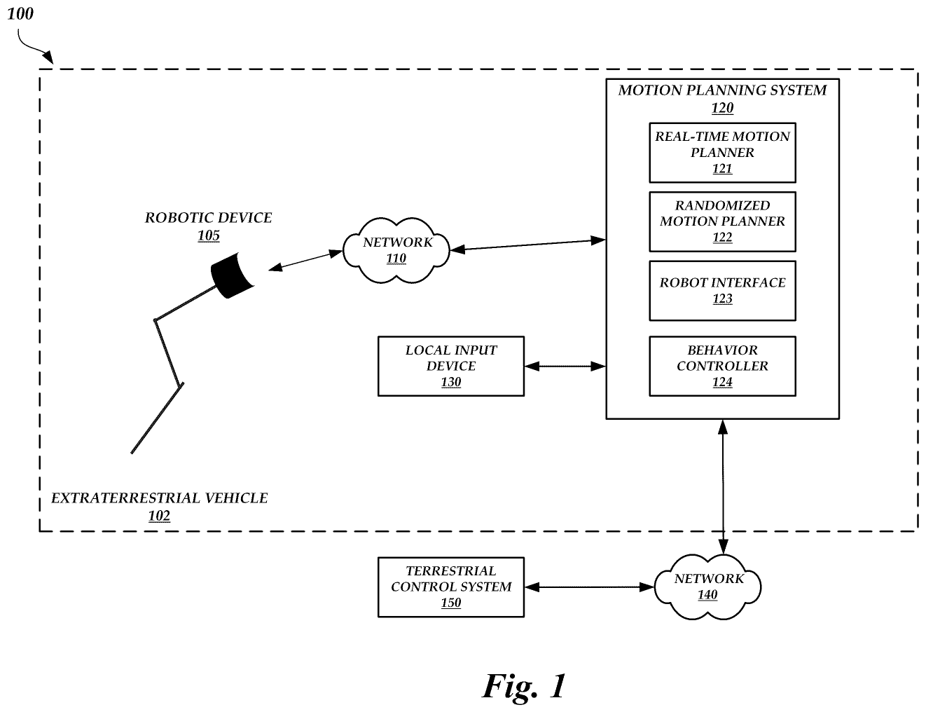

FIG. 1 is a block diagram of an illustrative operating environment 100 in which a motion planning system 120 determines a motion plan for a robotic device 105. The robotic device 105, the motion planning system 120, and a local input device 130 may be comprised within an extraterrestrial vehicle 102, such as a space lander, a rover, a rocket, a satellite, a spaceship, a space shuttle, and/or any other type of vehicle that is capable of operating in space and/or on an extraterrestrial object other than Earth. Thus, the robotic device 105 may be a component of the extraterrestrial vehicle 102. Alternatively or in addition, the motion planning system 120 can be remote from the extraterrestrial vehicle 102 and communicate with the extraterrestrial vehicle 102 via a network. The operating environment 100 further includes a terrestrial control system 150 that may communicate with the extraterrestrial vehicle 102 and/or the motion planning system 120 via a network 140.

The robotic device 105 may be an electromechanical structure that includes one or more joints or pivot points that connect one or more subcomponents of the structure. One of the subcomponents of the structure may be an end effector or gripper that is configured to perform one of several behaviors (e.g., follow, move to pose, move towards pose, grasp, release, scan, catch, throw, push, pull, handoff, drill, weld, etc.). Other subcomponents of the structure may be links (e.g., tubes or other enclosed housings) that supply power and/or commands to the end effector and that extend the reach of the end effector from a base of the robotic device 105 that couples to other components of the extraterrestrial vehicle 102. The joints or pivot points may allow each subcomponent to be oriented in a different direction and/or to move independently of each other such that the end effector can be moved from an initial position to a position of a target.

The robotic device 105 may communicate with the motion planning system 120 via a network 110. For example, the network 110 may include any wired network, wireless network, or combination thereof. For example, the network 110 may be a personal area network, local area network, wide area network, and/or the like.

The extraterrestrial vehicle 102 may include a local input device 130 that can be used to control the robotic device 105 indirectly via the motion planning system 120. For example, the local input device 130 may be a touchscreen, joystick, physical button, lever, keyboard, mouse, voice recognition system, gesture recognition system, mobile device (e.g., laptop, tablet, phone, remote, etc.), camera, and/or the like. Via the local input device 130, a user may be able to identify a target position to which the user would like to move the robotic device 105 and/or can identify a behavior for the robotic device 105 to perform (e.g., when at the target position).

The motion planning system 120 can be a computing system configured to generate and execute a motion plan. The motion planning system 120 may be a single computing device, or it may include multiple distinct computing devices, such as computer servers, logically or physically grouped together to collectively operate as a server system. The components of the motion planning system 120 can each be implemented in application-specific hardware (e.g., a server computing device with one or more ASICs) such that no software is necessary, or as a combination of hardware and software. In addition, the modules and components of the motion planning system 120 can be combined on one server computing device or separated individually or into groups on several server computing devices. In some embodiments, the motion planning system 120 may include additional or fewer components than illustrated in FIG. 1.

The motion planning system 120 may include various modules, components, data stores, and/or the like to provide the motion planning functionality described herein. For example, the motion planning system 120 may include a real-time motion planner 121, a randomized motion planner 122, a robot interface 123, and a behavior controller 124.

The real-time motion planner 121 can attempt to generate a motion plan using real-time motion planning techniques (e.g., Riemannian motion policy planning techniques) in response to an instruction received from the local input device 130 or a terrestrial control system 150 via network 140 to move the robotic device 105 to a target position. For example, the real-time motion planner 121 can obtain sensor data from the robotic device 105 via the robot interface 123. The robotic device 105 (e.g., some or all of the subcomponents of the robotic device 105) may have one or more sensors that are used to determine a current position of some or all of the subcomponents of the robotic device 105. These sensors can include rotational encoders, potentiometers, motion sensors, accelerometers, gyroscopes, and/or the like. The robotic device 105 may also have one or more other sensors that are used to detect a scene surrounding the robotic device 105, such as the position and/or orientation of objects in the vicinity of the robotic device 105. These sensors can include cameras, infrared sensors, light detection and ranging (lidar) sensors, radio detection and ranging (radar) sensors, and/or the like. The sensors of the robotic device 105 may measure the appropriate sensor data (e.g., position and/or orientation of a subcomponent, position and/or orientation of an object in the vicinity of the robotic device 105, etc.), and the robotic device 105 can transmit the sensor data to the real-time motion planner 121 via the network 110 and the robot interface 123.

The robotic device 105 can be represented in both a configuration space and a task space. The configuration space may be represented by a smooth Euclidean manifold that has a global set of coordinates. The task space may be a concatenation of three-dimensional positional space and three-dimensional orientational unit quaternion space, and may be represented by a Riemannian manifold. A tangent space may exist that intersects a portion of the Riemannian manifold and in which Euclidean operations may be allowed that are consistent with the constraints of the Riemannian manifold. In addition, a smooth task map may exist that maps the configuration space to the task space. A Riemannian motion policy may represent motions on the Riemannian manifold and can be represented by two components: a mapping of a pose (e.g., position) and velocity of an object to an acceleration of the object on the Riemannian manifold (e.g., an acceleration policy), and a matrix that defines a geometric structure of the Riemannian manifold. The acceleration policy may define the motion on the Riemannian manifold under the influence of a damped virtual potential field, which can lead to situations in which the real-time motion planner 121 fails to generate a working motion policy as described in greater detail below.

The task space can be decomposed into different subtask spaces. Thus, the overall task of moving the end effector to the target position can be decomposed into a set of subtasks that each represent goal-reaching or trajectory tracking for the end effector, collision avoidance for the links of the robotic device 105, and/or the like. The real-time motion planner 121 can therefore decompose the overall task into one or more subtasks using information indicating the movement of the end effector requested by a user (e.g., which indicates the goal to be reached) and the sensor data provided by the robotic device 105 (e.g., which indicates what objects with which to avoid collisions), and generate a Riemannian motion policy for each subtask that takes into account the requested movement and the sensor data provided by the robotic device 105. The real-time motion planner 121 can then generate a task map that includes the subtask(s) and a Riemannian motion policy for each of the subtasks. The subtasks, when combined, can represent the task space, and ultimately a global configuration space policy that defines a position and/or movement (e.g., velocity and/or acceleration) of the end effector (and/or other components of the robotic device 105) that result in the end effector of the robotic device 105 reaching the position of the target or a region surrounding the position of the target (e.g., a position that is within a threshold distance of the target position, such as within 10 m of the target position, within 1 m of the target position, within 10 cm of the target position, etc.).

The real-time motion planner 121 can construct a directed tree (e.g., a Riemannian motion policy tree) that encodes the structure of the task map. For example, the directed tree may include a root node, one or more child nodes that are children of the root node, and one or more leaf nodes that are each children of a child node. The root node may be connected to each child node via an edge that represents a smooth map from the Riemannian manifold of the root node to the Riemannian manifold of the child node. Similarly, each child node may be connected to each of its leaf nodes via an edge that represents a smooth map from the Riemannian manifold of the respective child node to the Riemannian manifold of the respective leaf node. Each node itself may represent a state (e.g., a position and/or velocity) on a Riemannian manifold and a Riemannian motion policy. For example, the root node may represent a state of the end effector of the robotic device 105 in the configuration space and a Riemannian motion policy of the end effector of the robotic device 105. The leaf nodes may each represent a different subtask, encoding a state of a subcomponent of the robotic device 105 and a Riemannian motion policy of the subcomponent. The real-time motion planner 121 can generate each of these nodes and combine the nodes using the edges to construct the directed tree. As described in greater detail below, the Riemannian metric of the Riemannian motion policy of the subcomponent (e.g., the matrix that defines a geometric structure of the Riemannian manifold) may be used as a weight by the real-time motion planner 121 when combining different subtasks.

To generate a global configuration space policy for the end effector of the robotic device 105, the real-time motion planner 121 can recursively traverse the constructed directed tree. For example, the real-time motion planner 121 can traverse the directed tree by performing recursive applications of a pushforward operation in a forward pass (e.g., propagate the state of a node in the directed tree to update the states of its child nodes, from root node to leaf nodes) and a pullback operation in a backward pass (e.g., propagate the natural form of a Riemannian motion policy from the child nodes to the parent node, from leaf nodes to the root node). The recursive application of the pushforward operation in the forward pass and the pullback operation in the backward pass may cause the real-time motion planner 121 to compute a weighted combination of the leaf node Riemannian motion policies, which has been propagated to the root node (e.g., representing a natural form Riemannian motion policy at the root node). The real-time motion planner 121 can then apply a resolve operation to map the Riemannian motion policy at the root node (e.g., the weighted combination of the leaf node Riemannian motion policies) from the natural form to its canonical form, thereby generating a global configuration space policy. The real-time motion planner 121 can repeat these operations for one or more time instances. Additional details of how a Riemannian motion policy is generated, how the directed tree can be traversed, and/or how the global configuration space policy is generated (e.g., by the real-time motion planner 121) can be found in Ratliff et al., “Riemannian Motion Policies,” dated Jan. 9, 2018; Ratliff et al., “Riemannian Motion Policies,” dated Jul. 25, 2018; Cheng et al., “RMPflow: A Computational Graph for Automatic Motion Policy Generation,” dated Apr. 5, 2019; and Le, “Learning Task-Parameterized Riemannian Motion Policies,” Institute of Parallel and Distributed Systems, dated Sep. 9, 2021; which are each hereby incorporated by reference herein in its entirety.

The real-time motion planner 121 can then evaluate, simulate, and/or otherwise assess the global configuration space policy to determine whether the policy, if executed, is able to move the end effector of the robotic device 105 to the target position. In some cases, the policy, when executed, is able to move the end effector of the robotic device 105 to the target position. In response, the real-time motion planner 121 may obtain instructions from the behavior controller 124 that define how the end effector is supposed to behave when reaching the target position, and instruct the robotic device 105, via the robot interface 123, to execute movements according to the policy to move the end effector to the target position and to execute one or more behaviors according to the instructions obtained from the behavior controller 124 when the target position is reached.

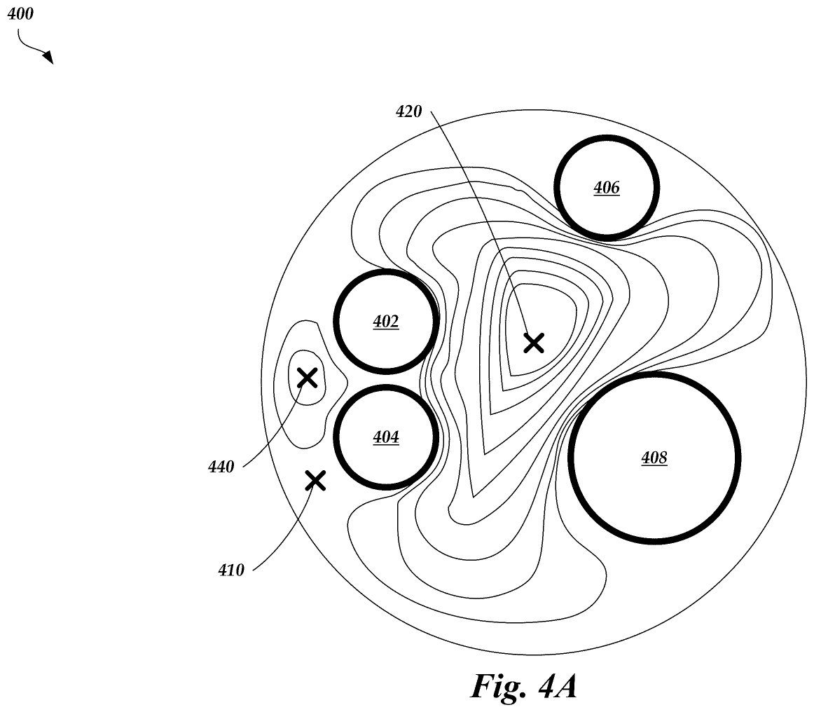

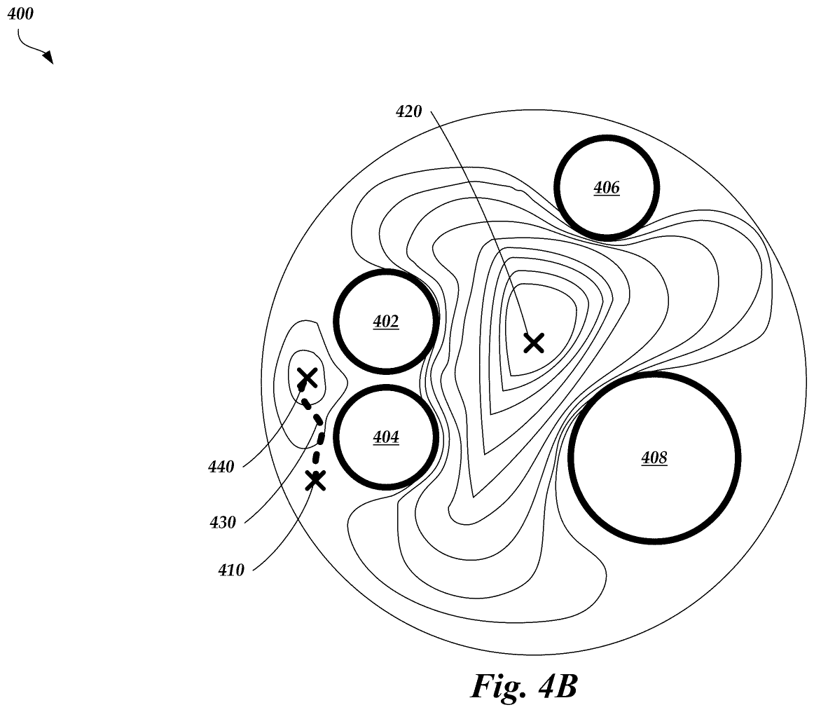

However, in other cases, the policy, when executed, is unable to move the end effector of the robotic device 105 to the target position. As described above, the acceleration policy of a Riemannian motion policy may define the motion on the Riemannian manifold under the influence of a damped virtual potential field. In a damped virtual potential field, there may be an attractive force at the target position and there may be repulsive force(s) from object(s) with which the robotic device 105 should not collide. The combination of attractive and repulsive forces may create one or more local minimums (e.g., positions at which an equilibrium state can be reached) that are in a different location than the target position (which might also represent a position at which an equilibrium state can be reached). If the initial position of the end effector happens to be near one of the local minimums, it is possible that the global configuration space policy may identify an equilibrium state in which the end effector rests at the nearby local minimum instead of at the target position. In other words, the global configuration space policy may not be able to define a set of movements that provides a path for the end effector to reach the target position (e.g., an equilibrium state at the target position) because repulsive force(s) from object(s) with which the robotic device 105 is not supposed to collide may cause the end effector to reach an equilibrium state at a nearby local minimum instead. This phenomenon is illustrated and described below with respect to FIGS. 4A-4B.

If the real-time motion planner 121 determines that the global configuration space policy is unable to move the end effector to the target position (or to a region within a threshold distance of the target position) (e.g., if the real-time motion planner 121 determines that the global configuration space policy identifies an equilibrium state of the end effector at a local minimum that is at a different location than the target position), then the real-time motion planner 121 may request the randomized motion planner 122 to generate a motion plan. The randomized motion planner 122 can subsequently determine a randomized motion policy for the robotic device 105. For example, the randomized motion planner 122 may use a rapidly exploring random tree approach in which the randomized motion planner 122 creates a search tree for finding a path from the initial position of the end effector to the target position. In particular, the randomized motion planner 122 creates a node in the search tree that represents an initial position of the end effector. The randomized motion planner 122 then selects a random position that is in the direction of the target position or that is within a threshold distance of the target position, finds a node in the search tree that is nearest to the selected random position (which may initially be the node representing the initial position of the end effector), and updates the search tree to add a node at the selected random position and a link between the nearest node and the newly added node if motion from the nearest node to the newly added node is collision-free (which may be indicated by the sensor data obtained from the robotic device 105). The randomized motion planner 122 can repeat these operations one or more times until a node is added to the search tree that is at the target position or in a region that is within the threshold distance of the target position.

Once the search tree is complete (e.g., a node is added to the search tree that is at the target position or in a region that is within the threshold distance of the target position), the randomized motion planner 122 and/or the real-time motion planner 121 can traverse the search tree to identify a shortest path between a node representing an initial state of the end effector and the node that is at or within a threshold distance of the target position. The shortest path may represent the randomized motion plan. Each intermediate node in the shortest path may represent an intermediate motion and/or position of the end effector as the end effector is moved from an initial position to the target position. Thus, the randomized motion planner 122 and/or real-time motion planner 121 can instruct the robotic device 105 via the robot interface 123 to move to one or more positions to reach the target position in a sequence dictated by the shortest path from the initial state node to the target position node. In addition, as described above, the randomized motion planner 122 and/or the real-time motion planner 121 may obtain instructions from the behavior controller 124 that define how the end effector is supposed to behave when reaching the target position, and instruct the robotic device 105, via the robot interface 123, to execute one or more behaviors according to the instructions obtained from the behavior controller 124 when the target position is reached.

Accordingly, the randomized motion planner 122 can generate a motion plan in instances in which the real-time motion planner 121 is unable to do so. As a result, the motion planning system 120 can implement a hybrid motion planning approach in which the default operation for the motion planning system 120 is to generate a deterministic, real-time motion plan, but to switch to generating a randomized motion plan if generation of the deterministic, real-time motion plan fails.

As described above, the robot interface 123 may serve as an interface between the motion planning system 120 and the robotic device 105. The robot interface 123 may receive sensor data from the robotic device 105 (e.g., via network 110) and can transmit instructions to the robotic device 105 (e.g., via network 110) to control the movement and/or behavior of the robotic device 105.

The behavior controller 124 can generate and provide to the real-time motion planner 121 and/or the randomized motion planner 122 instructions that define how the end effector is supposed to behave when reaching the target position. The behavior controller 124 may generate these instructions based at least in part on user input received via the local input device 130 and/or the terrestrial control system 150 that indicates the type of behavior that the user would like the robotic device 105 to perform.

The terrestrial control system 150 may be any computing device or set of computing devices capable of receiving user input indicating how to control the robotic device 105 and or transmitting instructions for controlling the robotic device 105 over a network 140. The terrestrial control system 150 may be located on Earth, in Earth's atmosphere, and/or on the surface of an extraterrestrial object (e.g., the Moon, a planet, a comet, an asteroid, etc.).

The network 140 may include any wired network, wireless network, or combination thereof. For example, the network 140 may be a personal area network, local area network, wide area network, over-the-air broadcast network (e.g., for radio or television), cable network, satellite network, cellular telephone network, or combination thereof. As a further example, the network 140 may be a publicly accessible network of linked networks, possibly operated by various distinct parties, such as the Internet. In some embodiments, the network 140 may be a private or semi-private network, such as a corporate or university intranet or an encrypted private network. The network 140 may include one or more wireless networks, such as a Global System for Mobile Communications (GSM) network, a Code Division Multiple Access (CDMA) network, a Long Term Evolution (LTE) network, or any other type of wireless network. The network 140 can use protocols and components for communicating via the Internet or any of the other aforementioned types of networks. For example, the protocols used by the network 140 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

### Example Block Diagram for Generating a Motion Plan Using a Hybrid Approach

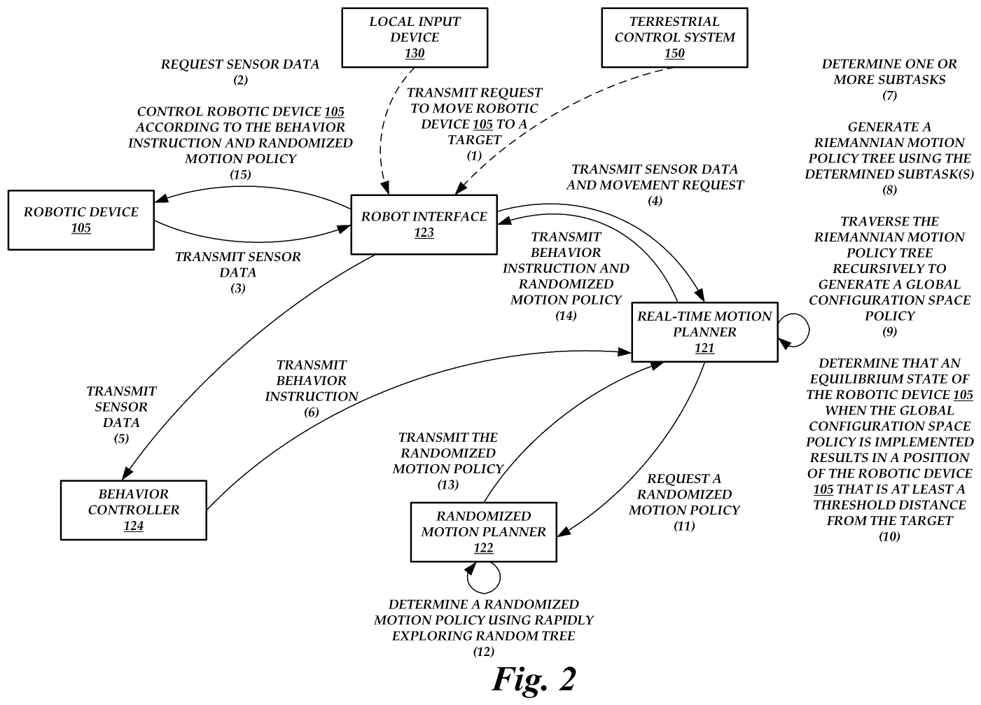

FIG. 2 is a flow diagram illustrating the operations performed by the components of the operating environment 100 of FIG. 1 to generate a motion plan using a hybrid approach. As illustrated in FIG. 2, the local input device 130 or the terrestrial control system 150 may transmit to the robot interface 123 a request to move the robotic device 105 to a target at (1). The request may include an indication of a position of the target, a time at which to move to the target, and/or a behavior to perform by the end effector of the robotic device 105 when the end effector reaches the target.

The robot interface 123 can request sensor data from the robotic device 105 at (2) in response, and the robotic device 105 can transmit the sensor data to the robot interface 123 at (3). Alternatively, the robotic device 105 may periodically transmit sensor data to the robot interface 123, in which case the robot interface 123 may not have to proactively request the sensor data. The robot interface 123 can then transmit the sensor data and movement request information to the real-time motion planner 121 at (4). The robot interface 123 may also transmit the sensor data and/or movement request information to the behavior controller 124 at (5). In response, the behavior controller 124 may generate a set of instructions for causing the robotic device 105 to perform a behavior requested by the user, and transmit the behavior instruction to the real-time motion planner 121 at (6).

The real-time motion planner 121 can attempt to generate a real-time motion plan. For example, the real-time motion planner 121 can determine one or more subtasks at (7). The real-time motion planner 121 can also generate a Riemannian motion policy for each of the determined subtasks at (8). The real-time motion planner 121 can then construct a Riemannian motion policy tree using the subtask(s) and then traverse the tree to generate a global configuration space policy at (9).

As described herein, the global configuration space policy may not result in the end effector of the robotic device 105 reaching the target. Here, the real-time motion planner 121 may determine at (10) that an equilibrium state of the robotic device 105 when the global configuration space policy is implemented results in a position of the robotic device 105 that is at least a threshold distance from the target. In other words, the real-time motion planner 121 may determine that implementing the global configuration space policy results in a position of the robotic device 105 (e.g., a position of the end effector of the robotic device 105) reaching an equilibrium state at a position other than a position of the target.

In response, the real-time motion planner 121 may request that the randomized motion planner 122 generate a randomized motion policy at (11). The randomized motion planner 122 can determine a randomized motion policy using, for example, a rapidly exploring random tree at (12). The randomized motion planner 122 can then transmit the randomized motion policy to the real-time motion planner 121 at (13).

The real-time motion planner 121 can transmit the behavior instruction and randomized motion policy to the robot interface 123 at (14). The robot interface 123 can then control operation of the robotic device 105 according to the behavior instruction and the randomized motion policy at (15).

### Example Virtual Potential Fields

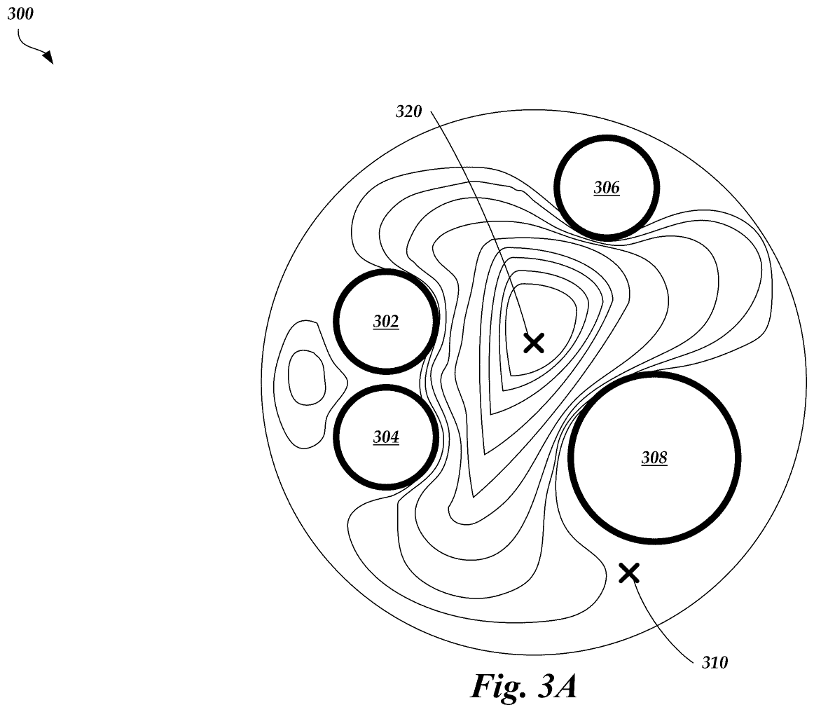

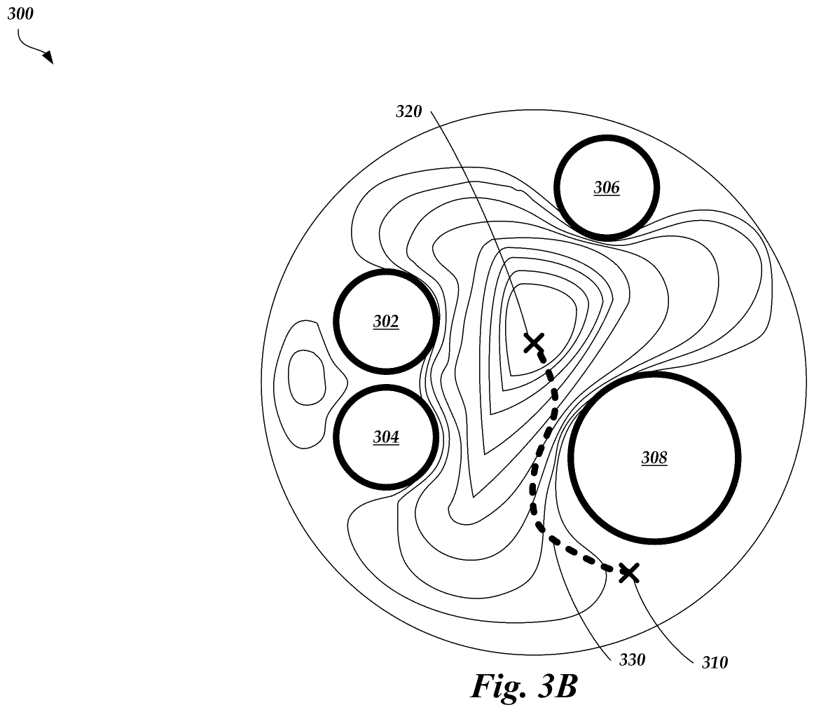

FIGS. 3A-3B illustrate an example virtual potential field 300. As illustrated in FIG. 3A, the virtual potential field 300 indicates the location of various obstacles 302, 304, 306, and 308 with which the robotic device 105 should avoid colliding. The virtual potential field 300 also indicates an initial position 310 of the end effector of the robotic device 105 and a target position 320 for the end effector of the robotic device 105.

As illustrated in FIG. 3B, given the location of the initial position 310 relative to the target position 320, the real-time motion planner 121 is able to generate a global configuration space policy that results in the end effector reaching the target position 320 (e.g., via path 330). As a result, the real-time motion planner 121 may instruct the robotic device 105 via the robot interface 123 to move the end effector along the path 330 to reach the target position 320.

FIGS. 4A-4B illustrate another example virtual potential field 400. As illustrated in FIG. 4A, the virtual potential field 400 indicates the location of various obstacles 402, 404, 406, and 408 that are located in the same positions as obstacles 302, 304, 306, and 308 of FIGS. 3A-3B and with which the robotic device 105 should avoid colliding. The virtual potential field 400 also indicates an initial position 410 of the end effector of the robotic device 105 a target position 420 for the end effector of the robotic device 105, and a local minimum 440.

As illustrated in FIG. 4B, given the location of the initial position 410 relative to the target position 420 and the local minimum 440, the real-time motion planner 121 may not be able to generate a global configuration space policy that results in the end effector reaching the target position 420. Rather, the end effector of the robotic device 105 may reach an equilibrium state by moving along path 430 to reach the local minimum 440. As a result, the real-time motion planner 121 may request a randomized motion plan from the randomized motion planner 122 so that a path other than the path 430 can be found to move the end effector toward the target position 420.

### Example Motion Policy Generation Routine

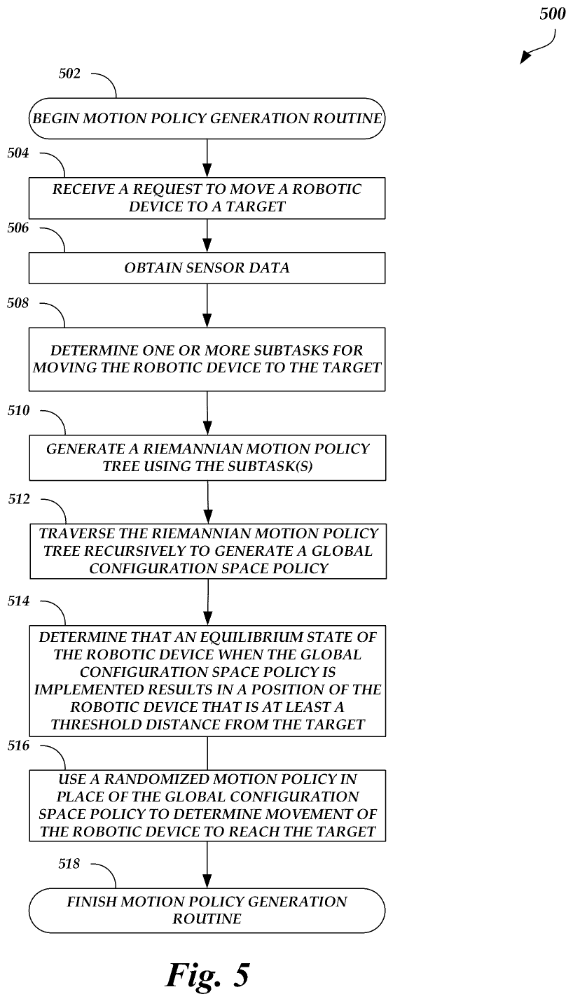

FIG. 5 is a flow diagram depicting an example motion policy generation routine 500 illustratively implemented by a motion planning system, according to one embodiment. As an example, the motion planning system 120 of FIG. 1 can be configured to execute the motion policy generation routine 500. The motion policy generation routine 500 begins at block 502.

At block 504, a request to move a robotic device to a target is received. For example, the request may indicate a type of behavior for the end effector of the robotic device to perform once the end effector of the robotic device reaches the target.

At block 506, sensor data is obtained. For example, the sensor data may be obtained from the robotic device. The sensor data may indicate the presence and/or location of obstacles in the vicinity of the robotic device and/or the position and/or orientation of one or more subcomponents (e.g., links, end effector, etc.) of the robotic device.

At block 508, one or more subtasks is determined for moving the robotic device to the target. For example, a subtask can represent goal-reaching or trajectory tracking for the end effector, collision avoidance for the links of the robotic device 105, and/or the like.

At block 510, a Riemannian motion policy tree is generated using the subtask(s). For example, each leaf node of the Riemannian motion policy tree may represent a subtask. The Riemannian motion policy tree may be a directed tree.

At block 512, the Riemannian motion policy tree is traversed recursively to generate a global configuration space policy. For example, a pushforward operation can be applied to the Riemannian motion policy tree in a first, forward pass, a pullback operation can be applied to the Riemannian motion policy tree in a second, backward pass, and a resolve operation can be applied to the results of the first and second passes to generate the global configuration space policy.

At block 514, it is determined that an equilibrium state of the robotic device when the global configuration space policy is implemented results in a position of the robotic device that is at least a threshold distance from the target. For example, the global configuration space policy, when implemented, may result in the end effector of the robotic device reaching an equilibrium state at a local minimum rather than at the target.

At block 516, a randomized motion policy is used in place of the global configuration space policy to determine movement of the robotic device to reach the target. For example, a randomized motion policy can be generated if the global configuration space policy fails to find a path that moves the end effector of the robotic device to the target. The randomized motion policy may be represented by a shortest path in a search tree. The randomized motion policy can then be implemented or executed (e.g., the robotic device can be instructed to move the end effector according to the randomized motion policy) such that the end effector of the robotic device moves to one or more positions indicated by nodes in the shortest path in the search tree until the end effector reaches the target. After the randomized motion policy is used, the motion policy generation routine 500 ends, as shown at block 518.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or logic circuitry that implements a state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system for generating a motion policy for a robotic device, the system comprising:
memory that stores computer-executable instructions; and
a processor in communication with the memory, wherein the computer-executable instructions, when executed by the processor, cause the processor to:
process a request to move a subcomponent of the robotic device to a target position;
obtain sensor data from the robotic device;
determine one or more subtasks for moving the subcomponent of the robotic device to the target position using the sensor data;
generate a directed tree using the determined one or more subtasks;
traverse the directed tree recursively to generate a global configuration space policy;
determine that the global configuration space policy, when implemented, results in the subcomponent of the robotic device reaching an equilibrium state at a second position that is at least a threshold distance from the target position;
generate a randomized motion policy in response to the determination that the global configuration space policy results in the subcomponent of the robotic device reaching the equilibrium state at the second position; and
cause the robotic device to move the subcomponent of the robotic device to the target position according to the randomized motion policy.

2. The system of claim 1, wherein the computer-executable instructions, when executed, further cause the processor to:
decompose an overall task of moving the subcomponent to the target position into the one or more subtasks; and
generate a Riemannian motion policy for each subtask in the one or more subtasks.

3. The system of claim 1, wherein the computer-executable instructions, when executed, further cause the processor to generate a root node, one or more child nodes, and one or more leaf nodes to form the directed tree, wherein each leaf node in the one or more leaf nodes represents one of the one or more subtasks.

4. The system of claim 1, wherein the computer-executable instructions, when executed, further cause the processor to:
apply a pushforward operation to the directed tree in a first pass;
apply a pullback operation to the directed tree in a second pass; and
apply a resolve operation to results of the pushforward operation and the pullback operation to generate the global configuration space policy.

5. The system of claim 1, wherein the computer-executable instructions, when executed, further cause the processor to:
select a random position that is between nodes of a search tree and the target position;
identify a first node in the search tree that is a closest node in the search tree to the selected random position;
determine that motion from the first node to the selected random position is collision-free;
add a second node to the search tree that corresponds to the selected random position and a link between the first node and the second node;
add one or more additional nodes to the search tree until one of the additional nodes is within the threshold distance of the target position; and
identify a shortest path between a third node in the search tree that represents an initial position of the subcomponent and the one of the additional nodes that is within the threshold distance of the target position, wherein the shortest path represents the randomized motion policy.

6. The system of claim 1, wherein the request to move the subcomponent comprises an indication of a location of the target position and an indication of a behavior for the subcomponent to perform when reaching the target position.

7. The system of claim 6, wherein the behavior comprises one of follow, move to pose, move towards pose, grasp, release, scan, catch, throw, push, pull, handoff, drill, or weld.

8. The system of claim 6, wherein the computer-executable instructions, when executed, further cause the processor to cause the subcomponent of the robotic device to perform the behavior when the subcomponent of the robotic devices reaches the target position.

9. The system of claim 1, wherein the subcomponent of the robotic device comprises an end effector of the robotic device.

10. The system of claim 1, wherein the directed tree comprises a Riemannian motion policy tree.

11. A computer-implemented method for generating a motion policy for a robotic device, the computer-implemented method comprising:
receiving a request to move a subcomponent of the robotic device to a target position;
determining one or more subtasks for moving the subcomponent of the robotic device to the target position;
generating a directed tree using the determined one or more subtasks;
traversing the directed tree recursively to generate a global configuration space policy;
determining that the global configuration space policy, when implemented, results in the subcomponent of the robotic device reaching an equilibrium state at a second position that is at least a threshold distance from the target position;
generating a randomized motion policy in response to the determination that the global configuration space policy results in the subcomponent of the robotic device reaching the equilibrium state at the second position; and
causing the robotic device to move the subcomponent of the robotic device to the target position according to the randomized motion policy.

12. The computer-implemented method of claim 11, wherein determining one or more subtasks further comprises:
decomposing an overall task of moving the subcomponent to the target position into the one or more subtasks; and
generating a Riemannian motion policy for each subtask in the one or more subtasks.

13. The computer-implemented method of claim 11, wherein generating a directed tree further comprises generating a root node, one or more child nodes, and one or more leaf nodes to form the directed tree, wherein each leaf node in the one or more leaf nodes represents one of the one or more subtasks.

14. The computer-implemented method of claim 11, wherein traversing the directed tree further comprises:
applying a pushforward operation to the directed tree in a first pass;
applying a pullback operation to the directed tree in a second pass; and
applying a resolve operation to results of the pushforward operation and the pullback operation to generate the global configuration space policy.

15. The computer-implemented method of claim 11, wherein generating a randomized motion policy further comprises:
selecting a random position that is between nodes of a search tree and the target position;
identifying a first node in the search tree that is a closest node in the search tree to the selected random position;
determining that motion from the first node to the selected random position is collision-free;
adding a second node to the search tree that corresponds to the selected random position and a link between the first node and the second node;
adding one or more additional nodes to the search tree until one of the additional nodes is within the threshold distance of the target position; and
identifying a shortest path between a third node in the search tree that represents an initial position of the subcomponent and the one of the additional nodes that is within the threshold distance of the target position, wherein the shortest path represents the randomized motion policy.

16. The computer-implemented method of claim 11, wherein the request to move the subcomponent comprises an indication of a location of the target position and an indication of a behavior for the subcomponent to perform when reaching the target position.

17. The computer-implemented method of claim 16, wherein the behavior comprises one of follow, move to pose, move towards pose, grasp, release, scan, catch, throw, push, pull, handoff, drill, or weld.

18. The computer-implemented method of claim 16, further comprising causing the subcomponent of the robotic device to perform the behavior when the subcomponent of the robotic devices reaches the target position.

19. A non-transitory, computer-readable medium comprising computer-executable instructions for generating a motion policy for a robotic device, wherein the computer-executable instructions, when executed by a computer system, cause the computer system to:
process a request to move a subcomponent of the robotic device to a target position;
generate a directed tree based on the request;
traverse the directed tree recursively to generate a global configuration space policy;
determine that the global configuration space policy, when implemented, results in the subcomponent of the robotic device reaching an equilibrium state at a second position that is at least a threshold distance from the target position;
generate a randomized motion policy in response to the determination that the global configuration space policy results in the subcomponent of the robotic device reaching the equilibrium state at the second position; and
cause the robotic device to move the subcomponent of the robotic device to the target position according to the randomized motion policy.

20. The non-transitory, computer-readable medium of claim 19, wherein the request to move the subcomponent comprises an indication of a location of the target position and an indication of a behavior for the subcomponent to perform when reaching the target position, and wherein the computer-executable instructions, when executed, further cause the computer system to cause the subcomponent of the robotic device to perform the behavior when the subcomponent of the robotic devices reaches the target position.
